(19) United States
(12) Patent Application Publication
(10) Pub. No.: US 2009/0274328 A1
(43) Pub. Date: Nov. 5, 2009

(54) APPARATUS AND METHOD FOR REDUCING INTERFERENCE EFFECTS IN THE CASE OF A WIRELESS DATA TRANSMISSION IN HEARING DEVICE APPLICATIONS

(76) Inventors: Volker Gebhardt, Neunkirchen am Brand (DE); Peter Nikles, Erlangen (DE); Gottfried Ruckerl, Numberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/434,931

(22) Filed: May 4, 2009

(30) Foreign Application Priority Data
May 5, 2008 (DE) 10 2008 022 126.0

(51) Int. Cl. H04R 25/00

(52) U.S. Cl. 381/331

(57) ABSTRACT

An apparatus and a method are provided for reducing an interference input coupling caused by asymmetrically embodied field lines of at least one hearing device component into a receiving antenna of a wireless data transmission facility of a hearing device. The apparatus includes at least one first means arranged in the hearing device, by means of which the asymmetry of the field lines is reduced and the field distortion is corrected. In addition, the receiving antenna can be geometrically adjusted to the outer interference field of the hearing device components such that interference currents induced in the antenna by means of field input coupling compensate.

### CROSS REFERENCE TO RELATED APPLICATIONS

This application claims priority of German application No. 10 2008 022 126.0 DE filed May 5, 2009, which is incorporated by reference herein in its entirety.

### FIELD OF INVENTION

The present invention relates to an apparatus and method for reducing interference effects in the case of a wireless data transmission in hearing device applications.

### BACKGROUND OF INVENTION

In the case of the inductive wireless transmission of data from a hearing device, a relay station, a programming device or a remote controller to a hearing device equipped with a suitable receiving facility, it is difficult for both the maximum transmission power and also the receiving sensitivity to be restricted. Due to the relatively small capacity, voltage and peak current load of the available hearing device batteries, the maximum transmission power of hearing devices is restricted.

On the other hand, legal restrictions exist in respect of the maximum transmission power of radio systems. A correspondingly restricted transmission range thus results. With present-day conventional inductive systems, the reduction in the field strength is highly crucial in the near field normally used, as a function of the distance.

Due to the low level of the useful signal at the receiver which results therefrom, already very low power sources of interference can massively influence the transmission quality. Essential components both of the transmission system as well as of the receiving hearing device nevertheless generate constructionally-specific electromagnetic emissions, which act as sources of interference in receiving systems. Such sources of interference are for instance the inductances of clocked voltage controllers, semiconductor components or supply and output lines of practically all clocked electronic circuits. The so-called receiver of the hearing devices is also an additional source of interference.

According to the prior art, shielding the source of interference with suitable materials, e.g. with a μ-metal or another suitable electrically conductive material is one measure. A so-called μ-metal contains metal alloys with a high permeability μ. These shield low frequency magnetic fields (so-called ferromagnetic shielding). The details of this can be found for instance in Zimmermann, J. E., SQUID Instruments and Shielding for low-level magnetic measurements. J. Appl. Phys.; 48:702-710, 1977.

A further known measure is, where possible, adequate distance between the transmitting and/or receiving coil in respect of the source of interference.

The publication DE 10 2006 049 471 A1 discloses a method for estimating an interference field for an antenna coil. Antennae and hearing device receivers can thus be positioned such that the interference is minimized by the hearing device receiver. FIG. 1 shows a schematic representation of the principle of a geometric calibration between the receiving antenna and the hearing device receiver functioning as a source of interference. The input coupling into the antenna is recorded in a meteorological fashion, the position of the antenna is optimized until the minimal input coupling is achieved. The position of the antenna in respect of the source of interference is then permanently fixed by suitable measures (adhesive, bracket).

### SUMMARY OF INVENTION

The object underlying the present invention is to prevent the illustrated difficulties in as effective and cost-effective a way as possible.

According to the invention, this object is achieved by an apparatus and a method as claimed in one of the independent claims. Advantageous developments of the invention result from the subclaims.

The invention claims an apparatus for reducing an interference input coupling caused by asymmetrically embodied field lines of at least one hearing device component into a receiving antenna of a wireless data transmission facility of a hearing device.

All components of a hearing device which are current-carrying or occupied with electrical charge transmit electromagnetic interference fields. The starting point of such interference signals are electrical supply lines (wires, stranded wires, conductors) or passive and active components. Significant interference signal sources in hearing devices are for instance clocked voltage controllers, analog and digital semiconductor components, supply and output lines of clocked circuits as well as the hearing device receiver. The field pattern of the radiated electrical and magnetic interference fields of a component depends on the form of the corresponding electrically conductive and/or magnetic parts as well as on electrically conductive and/or magnetic components in their vicinity.

The presence of electrically conductive and/or magnetic components in the hearing device results in a field distortion of the interference field. On the one hand, local zero points of the electrical and/or magnetic interference field distort or are lost. On the other hand, the distortion of the field lines results in an asymmetry of the input coupling into the receiving antenna. In both cases the interference input coupling into the receiving antenna increases. The outgoing electromagnetic interference signal is received at the site of the receiving antenna or a receiving coil of a wireless signal transmission system, which uses the inductive range or the typical HF range. The interference influence of the magnetic field on the receiving antenna depends on the amplitude and the direction of the magnetic field in respect of the alignment of the antenna. It is often not possible to sufficiently reduce the amplitude of the interference field at the site of the antenna using suitable shielding measures. If the magnetic field is preferably arranged at right angles to the receiving antenna, the interference field influence is minimized. The interference input coupling of the magnetic field into the receiving antenna can however also be reduced by using geometric arrangements, in which a symmetrical input coupling of the field lines takes place and the interference currents induced into the coil are thus largely erased. To this end, symmetry and/or radiation characteristics of the hearing device components can thus be used.

The apparatus according to the invention includes at least one first means arranged in the hearing device, by means of which the asymmetry of the field lines is reduced and the field distortion is corrected. In addition or alternatively, the receiving antenna can also be geometrically adjusted to the outer interference field of the hearing device components such that the interference currents induced by field input coupling are compensated in the antenna. As a result, the interference input coupling into the receiving antenna is reduced.

In accordance with the invention, the first means for reducing the asymmetry of the field lines has metallic properties.

A compensation plate is preferably used as a first means, which corrects the field distortion such that the input coupling is symmetrical again and the interference influence reduces.

In a further advantageous embodiment of the invention, already existing suitable metallic and/or magnetic hearing device components (e.g. microphone, shielding plates) can be used for the purpose of miniaturization as a first means instead of a compensation plate in order to compensate for the asymmetry of the field. As a result, an additional component can be avoided and the minimal space available in the hearing device can be optimally used for other hearing device components and/or the structural shape of the devices can be reduced.

In a further preferred embodiment, the receiving antenna has a coil bobbin, the winding of which has a variable tightness. As a result, the resulting induced interference currents are compensated in the antenna in the case of asymmetrical interference field input coupling.

In a further advantageous embodiment, the coil bobbin is asymmetrical, e.g. is embodied in conical form. This embodiment is then selected if the outer field has a field gradient in the coil direction.

The invention also claims a method for reducing an interference input coupling caused by asymmetrically embodied field lines into at least one hearing device component in a receiving antenna of a wireless data transmission facility of a hearing device. Here the asymmetrical field lines are corrected and/or compensated. In addition or also alternatively, a compensation of an induced interference current resulting due to the asymmetrical interference field input coupling takes place.

### BRIEF DESCRIPTION OF THE DRAWINGS

Further details and advantages of the invention are apparent from the descriptions that follow in respect of several exemplary embodiments with reference to schematic drawings, in which;

FIG. 1: shows a perspective view of a receiving antenna and a hearing device receiver functioning as an interference source,

FIG. 2a: shows a schematic view of an idealized symmetrical input coupling into an antenna,

FIG. 2b: shows a schematic view of an asymmetrical field distortion by means of metalizing a conductor board,

FIG. 2c: shows a schematic view of a compensation of a field asymmetry by means of a metal sheet according to an exemplary embodiment of the invention,

FIG. 3: shows a schematic view of the use of hearing device components to compensate for the asymmetry of an interference field input coupling in accordance with an exemplary embodiment of the invention,

FIG. 4a: shows a schematic view of a variation of the winding tightness of a coil bobbin in accordance with an exemplary embodiment of the invention,

FIG. 4b: shows a schematic view of an asymmetrical winding of a coil bobbin in accordance with an exemplary embodiment of the invention,

FIG. 4c: shows a schematic view of an asymmetrical coil bobbin in accordance with an exemplary embodiment of the invention and

FIG. 4d: shows a schematic view of a combination of a variation of the winding tightness of a coil bobbin and an asymmetrical coil bobbin in accordance with an exemplary embodiment of the invention.

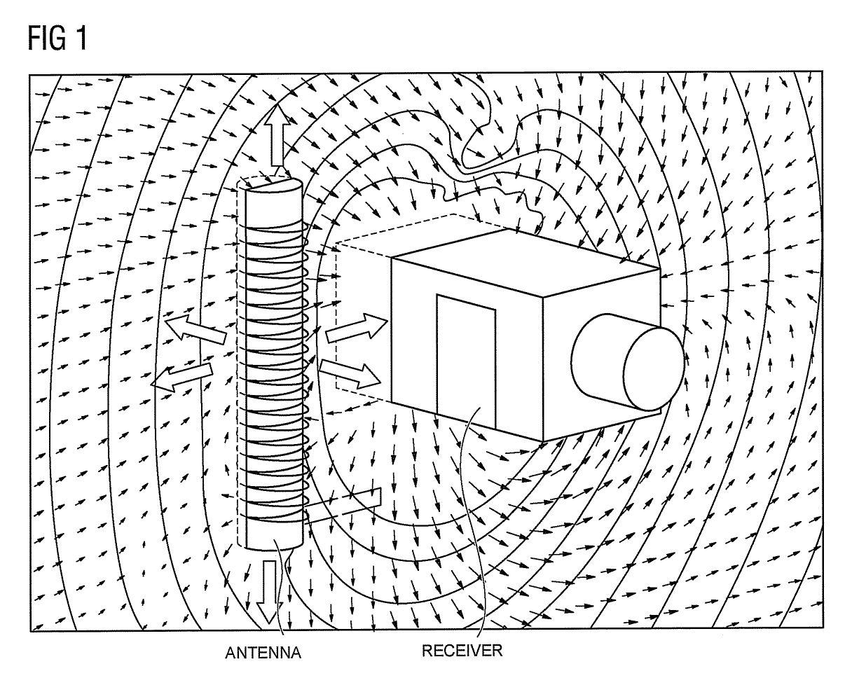

### DETAILED DESCRIPTION OF INVENTION

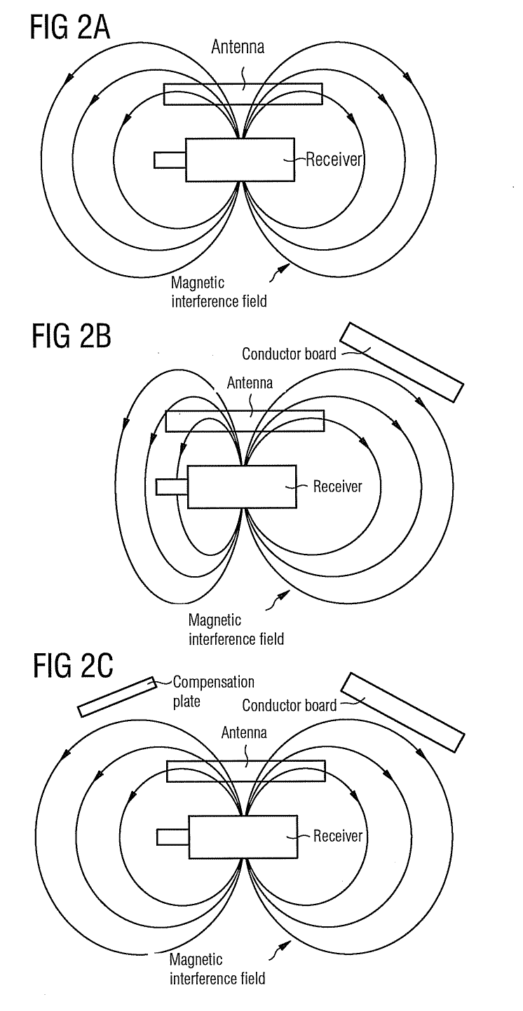

FIG. 2a shows the ideal state of an interference field of a receiver. The interference influence in an antenna is minimal as a result of a symmetrical input coupling, since induced interference currents are compensated.

In FIG. 2b, an interference field of a receiver is deformed by a metallization of a conductor board such that the interference influence in the antenna increases due to asymmetrical input coupling. The additional use of a thin metallic compensation plate compensates for the field distortion such that the input coupling is symmetrical again and induced interference currents are compensated.

FIG. 2c shows the use of a compensation plate, by means of which a field distortion is corrected, so that the input coupling is symmetrical again and the interference influence reduces.

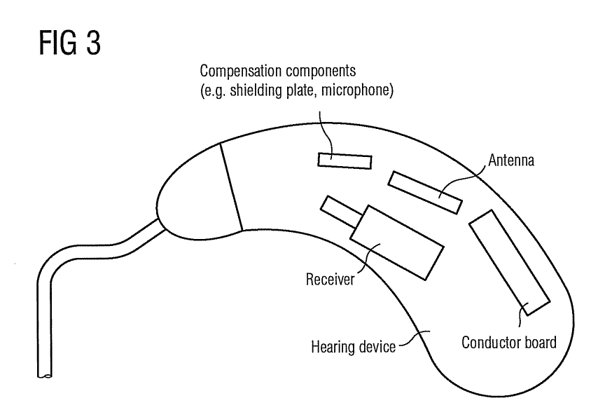

FIG. 3 shows, for the purpose of miniaturization, how already existing suitable metallic and/or magnetic hearing device components (e.g. microphone, shielding plates) can be used to compensate for a field asymmetry instead of a compensation sheet. An additional component can be avoided as a result and the minimal space available in the hearing device can be optimally used for other hearing device components and/or the structural shape of the device can be reduced.

The receiving antenna can be embodied geometrically such that with asymmetrical interference field input coupling the resulting induced interference currents in the antenna are compensated.

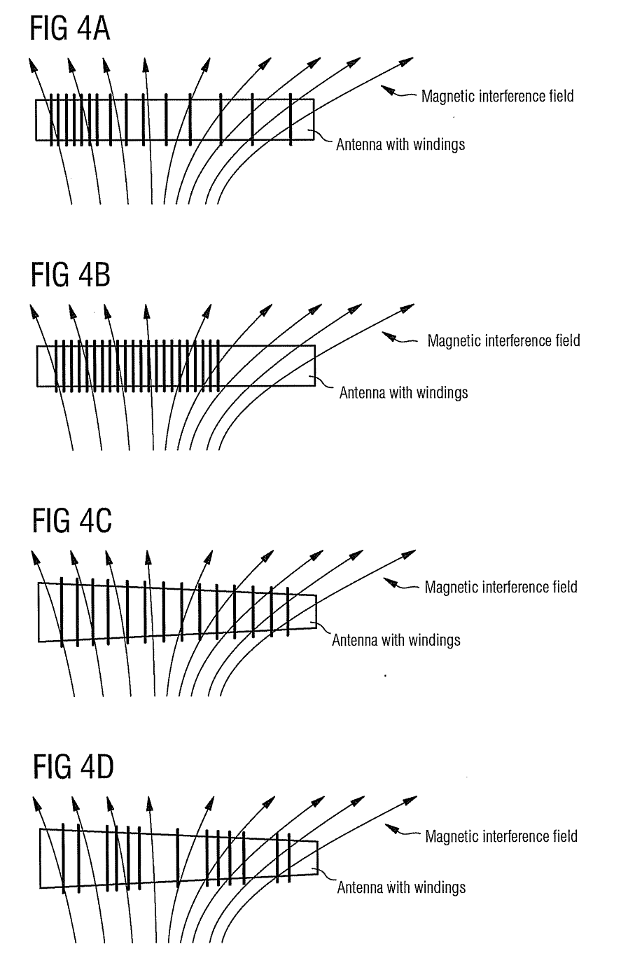

Further exemplary embodiments are shown in FIGS. 4a-4d. All possible combinations from the geometry of the coil bobbin and the winding tightness of the coil windings are conceivable in the case of an antenna coil. The coil bobbin can be embodied in a tapered fashion for instance or the winding tightness can be gradually reduced if the outer field has a corresponding field gradient in the coil direction. Both parameters can also be optimized in a computer-controlled fashion in the case of a known interference field. The adjustment of the coil geometry to the interference field is advantageous in that no additional components, like the plates for field shielding or for compensating the field asymmetry have to be introduced into the hearing device. The minimal space available in the hearing device can in turn be used optimally for other hearing device components or the structural shape of the hearing devices can be further minimized.

1.-10. (canceled)

11. An apparatus for reducing an interference input coupling produced by asymmetrically embodied field lines of at least one hearing device component into a receiving antenna of a wireless data transmission facility of a hearing device, comprising:
a first means arranged in the hearing device, which reduces the asymmetry of the field lines; and/or
a geometry of the receiving antenna, by which an induced interference current resulting from the asymmetrical interference field input coupling can be compensated.

12. The apparatus as claimed in claim 11, wherein the asymmetry of the field lines as a result of their distortion is caused by the presence of electrically conductive and/or magnetic components in the hearing device.

13. The apparatus as claimed in claim 12, wherein the hearing device components include clocked voltage controllers, semi-conductor components, supply and output lines of clocked switching circuits and a receiver.

14. The apparatus as claimed in claim 11, wherein the hearing device components include clocked voltage controllers, semi-conductor components, supply and output lines of clocked switching circuits and a receiver.

15. The apparatus as claimed in claim 11, wherein the first means is metallic.

16. The apparatus as claimed in claim 15, wherein the first means includes a compensation plate.

17. The apparatus as claimed in claim 15, wherein the first means includes at least one hearing device component.

18. The apparatus as claimed in claim 11, wherein the receiver antenna includes a coil bobbin and a winding surrounding the coil bobbin.

19. The apparatus as claimed in claim 18, wherein the winding surrounding the coil bobbin has a variable tightness.

20. The apparatus as claimed in claim 18, wherein the coil bobbin is asymmetrical.

21. A method for reducing an interference input coupling caused by asymmetrically embodied field lines of at least one hearing device component into a receiving antenna of a wireless data transmission facility of a hearing device, comprising:
compensating the asymmetrical field lines; and/or
compensating an induced interference current resulting from the asymmetrical interference field input coupling.

22. A hearing apparatus, comprising:
a wireless data transmission facility comprising a receiving antenna;
a hearing device component producing asymmetrically field lines thereby causing interference to the antenna;
a first means which reduces the asymmetry of the field lines; and/or
a geometry of the receiving antenna, by which an induced interference current resulting from the asymmetrical interference field input coupling can be compensated,

23. The hearing apparatus as claimed in claim 22, wherein the asymmetry of the field lines as a result of their distortion is caused by the presence of electrically conductive and/or magnetic components in the hearing device.

24. The hearing apparatus as claimed in claim 22, wherein the hearing device components include clocked voltage controllers, semi-conductor components, supply and output lines of clocked switching circuits and a receiver.

25. The apparatus as claimed in claim 22, wherein the first means is metallic.

26. The apparatus as claimed in claim 22, wherein the receiver antenna includes a coil bobbin and a winding surrounding the coil bobbin.

27. The apparatus as claimed in claim 26, wherein the winding surrounding the coil bobbin has a variable tightness.

28. The apparatus as claimed in claim 26, wherein the coil bobbin is asymmetrical.
